(19) United States
(12) Patent Application Publication
(10) Pub. No.: US 2012/0180527 A1
(43) Pub. Date: Jul. 19, 2012

(54) Method and System for Mitigation of Particulate Inclusions in Optical Materials

(75) Inventors: John Allyn Caird, San Francisco, CA (US); Kathleen Irene Schaffers, Livermore, CA (US)

(73) Assignee: Lawrence Livermore National Security, LLC, Livermore, CA (US)

(21) Appl. No.: 13/006,291

(22) Filed: Jan. 13, 2011

(51) Int. Cl. C03B 32/00; C03B 25/00; C03B 19/02

(52) U.S. Cl. 65/29.18; 65/83; 65/184; 65/158

(57) ABSTRACT

A method of fabricating an optical material includes providing input materials having a material softening temperature, melting the input materials, and flowing the melted input materials into a laser inclusion mitigation system. The melted input materials comprise one or more inclusions. The method also includes irradiating the input materials using a laser beam, fragmenting the one or more inclusions in response to the irradiating, and reducing a temperature of the input materials to less than the material softening temperature. The method further includes forming an optical material and annealing the optical material.

### STATEMENT AS TO RIGHTS TO INVENTIONS MADE UNDER FEDERALLY SPONSORED RESEARCH OR DEVELOPMENT

The United States Government has rights in this invention pursuant to Contract No. DE-AC52-07NA27344 between the United States Department of Energy and Lawrence Livermore National Security, LLC, for the operation of Lawrence Livermore National Security.

### BACKGROUND OF THE INVENTION

Projections by the Energy Information Agency and current Intergovernmental Panel on Climate Change (IPCC) scenarios expect worldwide electric power demand to double from its current level of about 2 terawatts electrical power (TWe) to 4TWe by 2030, and could reach 8-10 TWe by 2100. They also expect that for the next 30 to 50 years, the bulk of the demand of electricity production will be provided by fossil fuels, typically coal and natural gas. Coal supplies 41% of the world's electric energy today, and is expected to supply 45% by 2030. In addition, the most recent report from the IPCC has placed the likelihood that man-made sources of CO₂ emissions into the atmosphere are having a significant effect on the climate of planet earth at 90%. “Business as usual” baseline scenarios show that CO₂ emissions could be almost two and a half times the current level by 2050. More than ever before, new technologies and alternative sources of energy are essential to meet the increasing energy demand in both the developed and the developing worlds, while attempting to stabilize and reduce the concentration of CO₂ in the atmosphere and mitigate the concomitant climate change.

Nuclear energy, a non-carbon emitting energy source, has been a key component of the world's energy production since the 1950's, and currently accounts for about 16% of the world's electricity production, a fraction that could—in principle—be increased. Several factors, however, make its long-term sustainability difficult. These concerns include the risk of proliferation of nuclear materials and technologies resulting from the nuclear fuel cycle; the generation of long-lived radioactive nuclear waste requiring burial in deep geological repositories; the current reliance on the once through, open nuclear fuel cycle; and the availability of low cost, low carbon footprint uranium ore. In the United States alone, nuclear reactors have already generated more than 55,000 metric tons (MT) of spent nuclear fuel (SNF). In the near future, we will have enough spent nuclear fuel to fill the Yucca Mountain geological waste repository to its legislated limit of 70,000 MT.

Fusion is an attractive energy option for future power generation, with two main approaches to fusion power plants now being developed. In a first approach, Inertial Confinement Fusion (ICF) uses lasers, heavy ion beams, or pulsed power to rapidly compress capsules containing a mixture of deuterium (D) and tritium (T). As the capsule radius decreases and the DT gas density and temperature increase, DT fusion reactions are initiated in a small spot in the center of the compressed capsule. These DT fusion reactions generate both alpha particles and 14.1 MeV neutrons. A fusion burn front propagates from the spot, generating significant energy gain. A second approach, Magnetic fusion energy (MFE) uses powerful magnetic fields to confine a DT plasma and to generate the conditions required to sustain a burning plasma and generate energy gain.

Important technology for ICF is being developed primarily at the National Ignition Facility (NIF) at Lawrence Livermore National Laboratory (LLNL), assignee of this invention, in Livermore, Calif. There, a laser-based inertial confinement fusion project designed to achieve thermonuclear fusion ignition and burn utilizes laser energies of 1 to 1.3 MJ. Fusion yields of the order of 10 to 20 MJ are expected. Fusion yields in excess of 200 MJ are expected to be required in central hot spot fusion geometry if fusion technology, by itself, were to be used for cost effective power generation. Thus, significant technical challenges remain to achieve an economy powered by pure inertial confinement fusion energy.

### SUMMARY OF THE INVENTION

According to the present invention, techniques related to optical systems are provided. More particularly, embodiments of the present invention relate to mitigation of particulate inclusions present in optical elements. Merely by way of example, the invention has been applied to mitigation of platinum inclusions in passive and active optical elements using laser irradiation at temperatures above the softening or melting temperature of the bulk material. The methods and systems described herein are also applicable to other optical materials suitable for use with high power laser and amplifier systems.

The inventors have determined that the optical durability of a variety of laser optics is limited by the presence of particulate inclusions that are incorporated in the bulk material during the fabrication process. Embodiments of the present invention provide a high temperature laser processing technique that is performed while the bulk optical material is in a molten or plastic phase, such that the inclusions are fragmented and/or dispersed into smaller size particles or completely absorbed into the bulk optical material as a result of absorbing laser energy. In the high-temperature, plastic phase, the bulk optical material is able to reform or chemically react around the inclusion site to reduce the probability of laser damage and/or raise the damage threshold when an optical element fabricated from the bulk optical material is used in a high power laser system. As described more fully throughout the present specification, the laser, which is typically scanned across the optical material, has sufficient energy and short enough pulse duration to fragment large inclusions into one or more smaller inclusions. In some embodiments, the laser has a high enough repetition rate that laser irradiation raises the temperature of the inclusion site to a temperature at which local viscosity is reduced and chemical reactivity is increased, thereby dispersing and/or dissolving smaller particulates produced by laser irradiation.

According to an embodiment of the present invention, a method of fabricating an optical material is provided. The method includes providing input materials having a glass softening temperature and melting the input materials. The method also includes flowing the melted input materials onto a conveyor. The melted input materials comprise one or more inclusions. The method further includes irradiating the input materials using a laser beam, fragmenting the one or more inclusions in response to the irradiating, and reducing a temperature of the input materials to less than the glass softening temperature. Additionally, the method includes forming an optical material and annealing the optical material.

According to another embodiment of the present invention, a method of processing an optical element is provided. The method includes positioning the optical element in a processing system. The optical element initially includes at least one inclusion. The method also includes scanning a first laser beam across the optical element, detecting light from the first laser beam scattered from the at least one inclusion, and determining a location of the at least one inclusion. The method further includes directing a second laser beam to impinge on the at least one inclusion, irradiating the at least one inclusion, directing the first laser beam to impinge on the at least one inclusion, and determining that the at least one inclusion has been mitigated.

According to a specific embodiment of the present invention a system for fabricating optical materials is provided. The system includes a melt system operable to receive and melt input materials and a material feed system coupled to the melt system and operable to feed the melted input materials. The system also includes a conveyer system operable to receive the melted input materials and translate the melted input materials along a conveyer and an oven surrounding at least a portion of the conveyor. The system further includes a laser system operable to irradiate the melted input materials using a laser beam.

Numerous benefits are achieved by way of the present invention over conventional techniques. For example, embodiments of the present invention provide methods and systems suitable for reducing or eliminating inclusions in neodymium-doped phosphate laser glass, thereby increasing the damage resistance of the glass. Other embodiments increase the yield of the glass manufacturing process. In addition to Nd-doped phosphate laser glass, embodiments of the present invention are applicable to processing of Nd-doped silicate or other active laser glass media, glass lenses and windows, Faraday rotator glass, such as Tb-doped phosphate or silicate glass, crystalline laser gain media, e.g., rare-earth- or transition metal-doped crystals, nonlinear laser optical materials, or ceramic optical laser materials, for example, Nd- or Tb-doped oxide garnets or fluorites such as CaF₂, SrF₂, or the like. These and other embodiments of the invention along with many of its advantages and features are described in more detail in conjunction with the text below and attached figures.

### BRIEF DESCRIPTION OF THE DRAWINGS

FIG. 1 is a simplified schematic diagram of a system for manufacturing optical materials according to an embodiment of the present invention;

FIG. 2 is a simplified schematic diagram of an optical layout for a system for mitigating inclusions in an optical element according to an embodiment of the present invention;

FIG. 3 is a simplified schematic diagram of a control system layout for the system illustrated in FIG. 2;

FIG. 4 is a plot illustrating transmission properties of a Nd-doped phosphate glass;

FIG. 5 is a simplified flowchart illustrating a method of mitigating inclusions according to an embodiment of the present invention; and

FIG. 6 is a simplified flowchart illustrating a method of processing an optical element according to an embodiment of the present invention.

### DETAILED DESCRIPTION OF SPECIFIC EMBODIMENTS

Cost reduction is a desirable goal for high average power lasers. Currently, the semiconductor lasers (i.e., diode lasers) used as pumps sources for high average power lasers make the largest contribution to the overall laser system cost. The required amount of diode pump power scales inversely with the energy storage time of the laser gain medium. Therefore, increasing the energy storage time can result in a significant decrease in the overall laser system cost. Unfortunately, the energy storage time of conventional neodymium doped phosphate laser glasses are rather short—typically on the order of 400 μs or less. The energy storage time of other Nd-doped glasses can be several hundred microseconds longer (e.g., certain silicate laser glasses), but their chemical compositions are such that the presence of inclusions in the bulk material reduces their laser damage threshold and durability under high power laser operation.

Furthermore, the increased energy storage lifetime is accompanied by a similar increase in the saturation fluence (i.e., the energy flux required to efficiently extract stored energy), which results in materials with longer energy storage times that require higher damage thresholds at efficient operating points. Therefore, there is a need in the art for improved methods and systems for reducing or eliminating inclusions in laser materials with longer energy storage lifetimes and/or increasing the damage thresholds of such materials.

In general, foreign particulate inclusions in laser optical materials significantly reduce their damage threshold and resulting durability. High average power laser systems, such as those operated at LLNL, as well as other government, academic, and commercial facilities, will therefore benefit from high damage threshold optics. Optical materials with higher damage thresholds or optical durability can be used to increase the performance of a laser, and therefore have higher economic value than materials with lower damage thresholds. Embodiments of the present invention reduce the number of inclusions in the optical element and enhance the value of the optical elements as well as the yield of high quality, inclusion-free parts. Embodiments of the present invention are applicable to a wide variety of optically active materials, including neodymium-doped laser amplifier glass, passive optics including lenses and windows, nonlinear optics including frequency conversion crystals, and optical ceramics. This list of optical elements is provided merely by way of example and is not intended to limit the scope of the present invention.

Currently, neodymium-doped phosphate glasses are used in high energy laser systems because they provide beneficial features including the ability to be manufactured in very large sizes (e.g., (46 cm×81 cm×4 cm for NIF amplifiers) by the continuous melt method. Embodiments of the present invention are applicable to such high average power lasers as well as high average power laser systems that operate at high repetition rate (e.g., ˜10 Hz for lasers used in the LIFE program) for which inexpensive, defect free optics are useful. For Nd-doped phosphate glass, the density of platinum inclusions is greatly reduced by oxidation and dispersal of platinum inclusions to a benign ionic form in the molten-glass state. After cooling to ambient temperature, the pre-final polished Nd:glass material is raster scanned with a Nd:YAG laser to locate and explode any inclusions that may remain. This process results in a finite number of damage sites in the glass, and allows assessment of the utility of the glass for laser applications. Material with zero damage sites present after raster scanning has the highest damage threshold or optical durability, and is suitable for use in applications where the highest laser irradiance is required. Material with a small number of damage sites may be acceptable for use in applications where the laser irradiance is not so high. Material with an excessive number of damage sites is rejected. Embodiments of the present invention are useful in reducing or eliminating lower quality and rejected laser material, resulting in increased manufacturing yield and cost savings.

Currently, the utility of certain optical materials is limited because of the difficulty of eliminating inclusions present in these optical materials. As an example, some neodymium-doped silicate glasses, which would otherwise be attractive for use in high average power lasers, have seen limited use because of the presence of inclusions that adversely impact the performance of optical elements fabricated from these neodymium-doped silicate glasses, also referred to as silicate laser glasses. Silicate laser glasses typically have longer energy storage lifetimes, can be used at higher energy storage density, are less hygroscopic (i.e., more resistant to surface fogging with ambient humidity), and have better thermo-mechanical properties than comparable phosphate glasses. However, the solubility of platinum and other metals in silicate glasses is substantially less than that in phosphate glasses. As a result, the process of oxidation and dispersal of platinum to a benign ionic form by the methods described above is generally ineffective. In order to overcome these and other problems, embodiments of the present invention provide methods and systems that reduce or eliminate inclusions in silicate glasses, making them attractive candidates for high average power laser applications.

Fragmentation of inclusions into smaller particulates increases their ratio of surface area to volume ratio, thereby increasing their rate of dissolution into the matrix of the material. Although traditional post-fabrication raster scanning reduces the damage risk caused by platinum inclusions, it is an additional step that requires technician handling, which can be expensive, and is not completely effective. According to an embodiment of the present invention, laser raster scanning is performed in-situ with the glass forming step. This method eliminates the additional laser raster scanning step as well as potentially increasing the damage threshold of an optic by allowing self healing of the material around residual defects while it is still soft enough to flow.

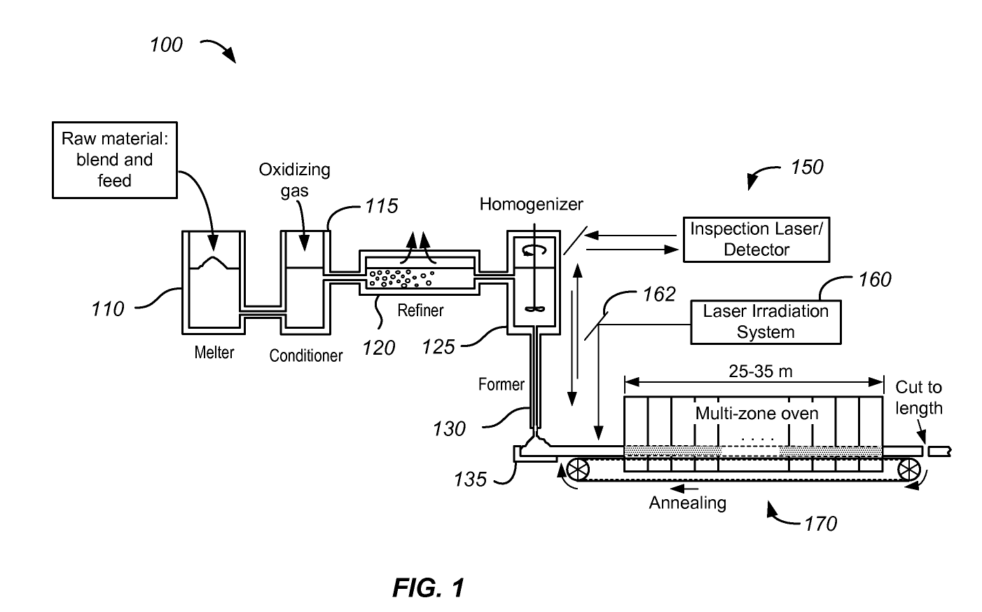

FIG. 1 is a simplified schematic diagram of a system for manufacturing optical materials according to an embodiment of the present invention. The system illustrated in FIG. 1 performs in-situ processing of optical materials using laser scanning during the fabrication process to reduce or eliminate inclusions including metallic platinum inclusions. The inclusions are not limited to metallic platinum, but can include other materials suitable for crucible fabrication. As examples, the inclusions can include metallic iridium, metallic tungsten, metallic molybdenum, metal oxides, metal fluorides, ceramics, combinations thereof, or the like. Referring to FIG. 1, as discussed in additional detail below, laser scanning is performed as a step prior to or following the melt being fed onto a belt for cooling and annealing. In the embodiment illustrated in FIG. 1, a continuous pour glass melt process is illustrated. As shown in FIG. 1, the interaction between the laser beam and the materials being produced reduces or eliminates inclusions, resulting in improved performance of the optical elements manufactured using the materials resulting from the fabrication process. In some embodiments, the glass is in a molten or plastic phase during the laser interaction.

Referring to FIG. 1, a system 100 for mitigating inclusions is illustrated. In the system illustrated in FIG. 1, laser scanning of the optical material is performed at high temperature during the fabrication of the optical material. In this embodiment, the optical material is in a molten or plastic state (e.g., prior to a glass melt being fed onto a belt for cooling and annealing). In other embodiments, the laser scanning is performed during high temperature post processing (e.g., during later thermal annealing). Although laser scanning is illustrated in the embodiment illustrated in FIG. 1, the present invention is not limited to this particular implementation and laser irradiation without a scanning functionality is included within the scope of the present invention.

Particulate inclusions present in the optical material after forming will absorb the scanning laser energy, fragment into smaller pieces, disperse, and in this softened phase, allow the material an opportunity to dissolve the smaller particulates and/or reform around the remaining smaller fragments to lessen the probability of subsequent laser damage or to raise the local damage threshold. Embodiments of the present invention are applicable to a wide variety of optical materials including active and passive materials such as glass and laser gain media.

As illustrated in FIG. 1, raw materials are blended and fed into a melter 110 in which the raw materials are melted and large scale mixing is performed. The melted raw materials are passed to a conditioner 115 in which the raw materials are dehydrated and exposed to an oxidizing gas to set the redox state. A refiner 120 is used to remove bubbles and refine the conditioned materials. The refined material is thoroughly mixed in homogenizer 125 and flows in a molten state through former 130. The flow through the former 130 is controlled to form strain-free glass on the support surface 135. Inclusions are present in the strain-free glass formed using this system, because, for example, the various vessels (melter, conditioner, etc.) are typically lined in platinum or another refractory metal. During processing, these metals are thus incorporated into the bulk of the optical material as particulates.

The system 100 also includes an optional inspection system 150 and a laser irradiation system 160. The optional inspection system 150 includes a low power laser that is used to detect the presence of inclusions in the optical material. The low power laser can be scanned across the optical material and a detector is used to collect and detect light scattered from the optical material. In the illustrated embodiment, the optional inspection system 150 uses scattered light to detect inclusions, but in other embodiments, light emitted from or absorbed by the optical material could be detected to detect the presence of inclusions. In an embodiment, the low power laser is scanned across the optical material and scattered light is used to indicate the presence and location of inclusions, also referred to as defects. Various optical elements including lenses, mirrors, apertures, motion stages, controllers, sensors, and the like are utilized in conjunction with the optional inspection system 150 but are not illustrated for purposes of clarity.

The laser irradiation system 160 includes a high power laser that is used to fragment the inclusions into smaller pieces and/or disperse them. In an embodiment, the high power laser utilized in the laser irradiation system 160 is an Nd:YAG laser operating at or near a wavelength of 1064 nm. In other embodiments, other high power lasers with suitable characteristics are used. Because the optical material is at a high temperature (e.g., above the glass softening or melting temperature) and in a softened phase, it is possible for the material to effectively dissolve the defects. According to some embodiments, processing is performed at or near a glass transition temperature. In other embodiments, a processing temperature is used at which the material softens and/or becomes more conducive to chemical changes that facilitate the inclusion dispersal process described herein. Thus, embodiments of the present invention are applicable to materials processed at or near the glass transition temperature as well as higher temperatures. Additionally, embodiments of the present invention are applicable to materials such as ceramic or crystalline laser materials for which there is no glass transition temperature, but for which processing at elevated temperatures just below the melting point is beneficial.

In an embodiment, once the inclusions are located using the optional inspection system 150, a control system (not shown for purposes of clarity) is used to direct the high power laser to impinge on the location of the inclusion. In some implementations, the high power laser is scanned using optics including mirror 162 and the scan rate is decreased or reduced to zero (impingement position of high power laser on the glass is stopped) and the optional inspection system is used to determine when sufficient mitigation of the inclusion has occurred. As an example, once the scattering from the defect decreases below a threshold level, the high power laser once again resumes scanning The determination that sufficient mitigation has occurred can be a sufficient reduction in the amount of scattered light from the location of the inclusion, a change in the temporal and/or spectral properties of the scattered light, or the like. In some embodiments, the position of the focal spot of high power laser is varied around the location of the inclusion to enhance or ensure process efficacy. Various optical elements including lenses, mirrors, apertures, motion stages, controllers, sensors, detectors, and the like are utilized in conjunction with the laser irradiation system 160 but are not illustrated for purposes of clarity. One of ordinary skill in the art would recognize many variations, modifications, and alternatives.

After mitigation of the inclusions, the optical material passes into a multi-zone oven 170 for heat treatment and annealing. The optical material, for example, sheets of glass, can be cut to size after heat treatment and annealing. Although laser processing to mitigate inclusions is illustrated in FIG. 1 as occurring prior to entry into the multi-zone oven, other embodiments perform laser processing of the optical material in which the material is in a high temperature, molten, or near molten state within the multi-zone oven or other high temperature enclosure (e.g., a furnace or annealing apparatus). Although the high power laser is typically scanned across the optical material, this is not required by the present invention and other embodiments utilize an x-y translation stage to translate the optical materials with respect to the laser beam. One of ordinary skill in the art would recognize many variations, modifications, and alternatives.

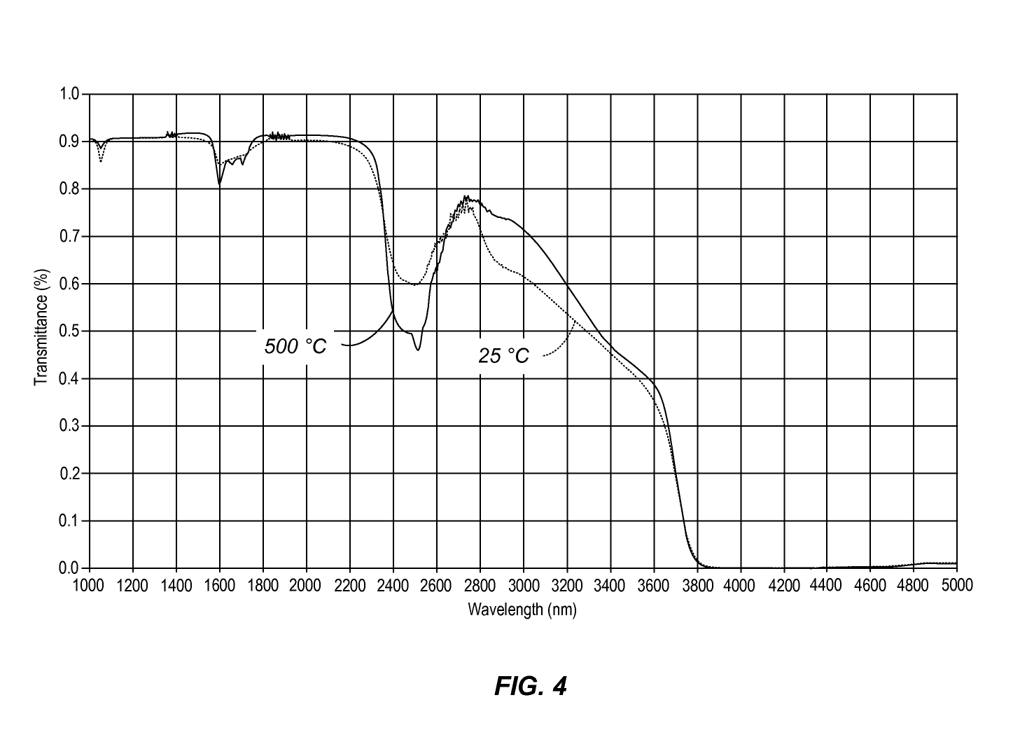

FIG. 4 is a plot illustrating transmission properties of Nd-doped phosphate glass at two temperatures. As illustrated in the figure, embodiments of the present invention utilize laser systems and optical materials such that the optical material being processed has sufficient optical transmission at suitable laser wavelengths to penetrate the material to the depth of the inclusions at the process temperature. For Nd-doped phosphate glass, as illustrated in FIG. 4, at temperatures ranging from 25° C. to 500° C., the illustrated glass has sufficient transparency at near infrared wavelengths at which laser sources are readily available (e.g., 1064 nm), to enable both detection and mitigation of inclusions. Referring to FIG. 4, at temperatures ranging from about 25° C. to 500° C., the optical transmittance is approximately 90% at 1064 nm (note that the difference from 100% is largely due to Fresnel reflection from the two surfaces, and that much thicker components can be processed). Thus, this illustrates glass supports propagation of an irradiating beam that can pass through the sample in order to irradiate an inclusion.

Since the glass transition temperature is below 500° C. for the illustrated Nd-doped phosphate glass sample, processing at temperatures up to, near, and above the glass transition temperature is possible. Thus, embodiments of the present invention enable optimization of the inclusion mitigation process at temperatures up to at least the glass transition temperature and above for many types of optical materials. In addition to Nd-doped phosphate glass, other optical materials with sufficient optical transparency at processing temperatures will be suitable for processing as described herein.

According to some embodiments of the present invention, the pulse duration of the high power laser ranges from about 0.1 ns to about 100 ns. The particular pulse duration will be a function of the properties of the optical material to be processed and the inclusions or defects being mitigated. In embodiments in which the optional inspection system is not utilized, the entire bulk of the optical material can be scanned or otherwise processed at an optical energy fluence high enough to fragment and disperse defect particulates. As discussed in relation to FIG. 4, lasers having a lasing wavelength within a spectral transmission window associated with the optical material of interest and at the process temperature are utilized in embodiments of the present invention.

The pulse repetition rate of the high power laser is selected depending on the particular mitigation process. Dispersal of individual inclusions or defects can be enhanced at high repetition rates in which multiple pulses result in a significant increase of the local temperature. As the local temperature increases, the reactivity of the constituents increases, and the local area can melt and/or the local viscosity can decrease, allowing for more rapid chemical reactions and mixing to enhance dispersal of the inclusion.

Some embodiments of the present invention reduce or eliminate inclusions in optical materials through the use of a laser system that is operable to heat the optical materials to a temperature near or above the melting point (also referred to as a plastic phase) so that the material viscosity is reduced and the inclusions can be more readily dissolved and/or diffused and/or oxidized into the bulk of the optical material. If irradiation by the laser results in vaporization of an inclusion, the fact that the optical material is in a molten or near-molten state with low viscosity enables the materials originally associated with the inclusion to be dispersed and/or dissolved within the bulk of the optical material. Additionally, an annealing process may occur associated with or after the dispersion process.

Embodiments of the present invention are particularly well suited to applications for silicate glasses. In these silicate materials, platinum, for example, ionic platinum, has a lower solubility than the solubility characterizing other material systems, for example, phosphate glasses. In other words, platinum has a higher solubility in phosphate glasses than it does in silicate glasses. Thus, embodiments of the present invention open up opportunities to use glasses other than phosphate glasses in high fluence applications, for example fluorophosphates, tellurites, borosilicates, BK7, ED-2 (Owens-Illinois), LG-660 (Schott), and fused silica among other materials. As will be evident to one of skill in the art, silicate glasses can be superior to phosphate glasses in several areas, including thermal conductivity, strength, hygroscopic characteristics, and fracture toughness. Thus, by reducing the density of inclusions (e.g., metallic platinum) in the matrix, embodiments of present invention open up opportunities for new material systems. Merely by way of example, inexpensive glasses typically characterized by inclusions could be fabricated or processed using embodiments of the present invention to replace expensive fused silica optics commonly used in high power applications. Furthermore, this may allow for cheaper forming methods of glasses, like fused silica, and neodymium-doped fused silica, that would otherwise result in an unacceptable density of inclusions to be present in the glass. In addition to glass materials, crystal materials, including laser crystals such as YAG, SFAP, calcium fluoride, are suitable for use according to embodiments of the present invention. One of ordinary skill in the art would recognize many variations, modifications, and alternatives.

Embodiments of the present invention are suitable for fabrication of optical elements used in nuclear systems. Suitable nuclear systems include, but are not limited to, hybrid fusion-fission systems, a Laser Inertial-confinement Fusion Energy (LIFE) engine, hybrid LIFE systems such as a hybrid fusion-fission LIFE system, a generation IV reactor, an integral fast reactor, magnetic confinement fusion energy (MFE) systems, accelerator driven systems and others. In some embodiments, the nuclear system is a hybrid version of the LIFE engine, a hybrid fusion-fission LIFE system, such as described in International Patent Application No. PCT/US2008/011335, filed Mar. 30, 2008, titled “Control of a Laser Inertial Confinement Fusion-Fission Power Plant”, the disclosure of which is hereby incorporated by reference in its entirety for all purposes.

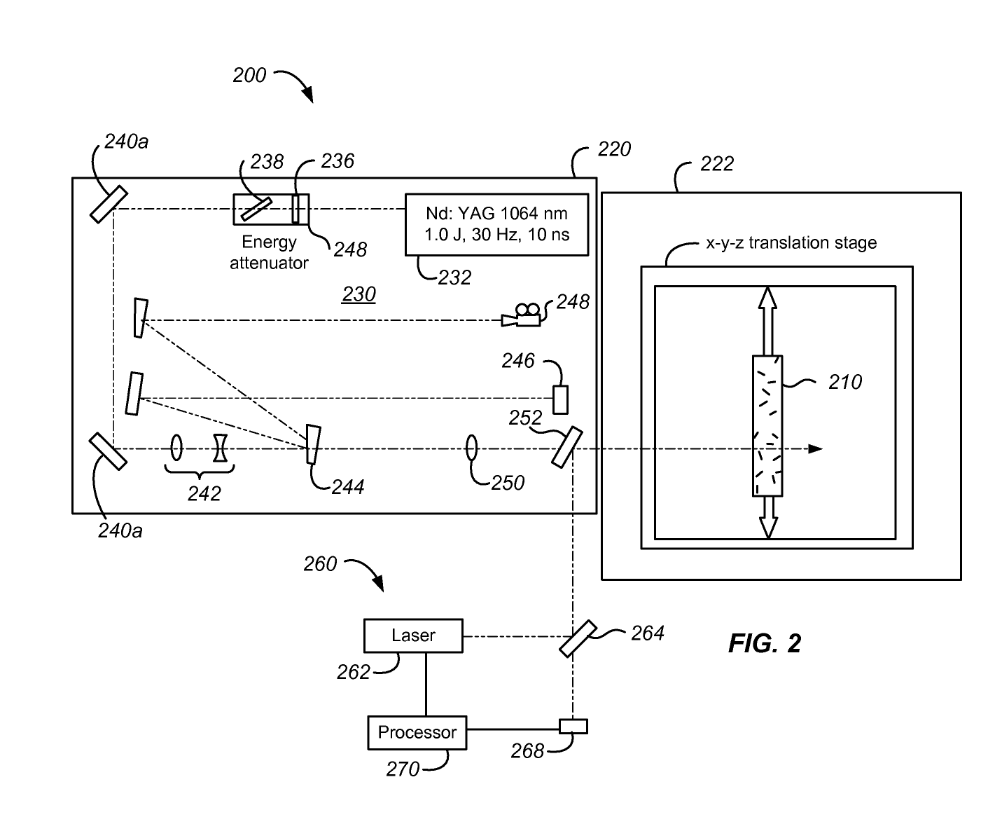

FIG. 2 is a simplified schematic diagram of an optical layout for a system for mitigating inclusions in an optical element according to an embodiment of the present invention. In the embodiment illustrated in FIG. 2, an optical element 210 is illustrated after initial manufacturing. As an example, the optical element could be a laser gain medium, a lens, or other optical element fabricated using conventional processing techniques such that inclusions are present in the optical element. Merely by way of example, a Nd-doped silicate glass slab suitable for use as a laser gain medium could be processed using the system 200 illustrated in FIG. 2. A first enclosure 220 and a second enclosure 222 are utilized to house laser processing system 230 and the optical element 210, respectively. In the illustrated embodiment, second enclosure 222 is a high temperature environment in which the optical element can be maintained at a temperature near (including below and above) the glass transition temperature of the optical element. Heating elements are not illustrated for the purpose of clarity.

The laser processing system 230 includes a high power laser 232, for example, a Nd:YAG 1064 nm laser having an energy output of 1.0 J, producing 10 ns pulses at a repetition rate of 30 Hz. The high power laser 232 is directed through an energy attenuator 234, which can be fabricated using a half waveplate 236 and a polarizer 238. Light is directed toward the second enclosure using one or more mirrors 240 and optics 242. A beam splitter 244 is used to sample the laser beam, providing inputs for an energy detector 246 and a CCD camera 248. Scanning optics 250 are used to scan the laser beam across the optical element 210.

Referring to FIG. 2, an inspection system 260 is provided to scan the optical element 210 and detect the locations of the inclusions. The inspection system 260 is located within first enclosure 220 in some embodiments. The inspection system includes a low power laser 262 and optics 264, which include a scanning system. Light scattered from the inclusions is reflected from beam splitter 252 and detected at detector 268 and the locations of the inclusions are determined using processor 270. The locations of the inclusions are utilized by the laser processing system 230 in directing the high power laser 232 to impinge on the inclusions.

In the embodiment illustrated in FIG. 2, the optical element is raised to a predetermined temperature, e.g., a temperature near or above the glass transition temperature, and metallic inclusions are removed and/or mitigated post fabrication. The optical element 210 can be supported on a processing table (not shown for purposes of clarity) that provides mechanical support for the optical element 210 and is compatible with the high temperature processing environment. In some embodiments, optical elements exposed to higher energy fluences are processed to reduce the inclusions to a level lower than other optical elements that are only exposed to lower energy fluences. Thus, embodiments of the present invention can provide a tailored approach to post-fabrication processing, providing minimal processing for low-fluence optics and more extensive processing for high-fluence optics. Moreover, optics that are initially unsuitable for high fluence operation can be processed to increase the damage threshold of the optics, thereby increasing manufacturing yield and reducing system cost.

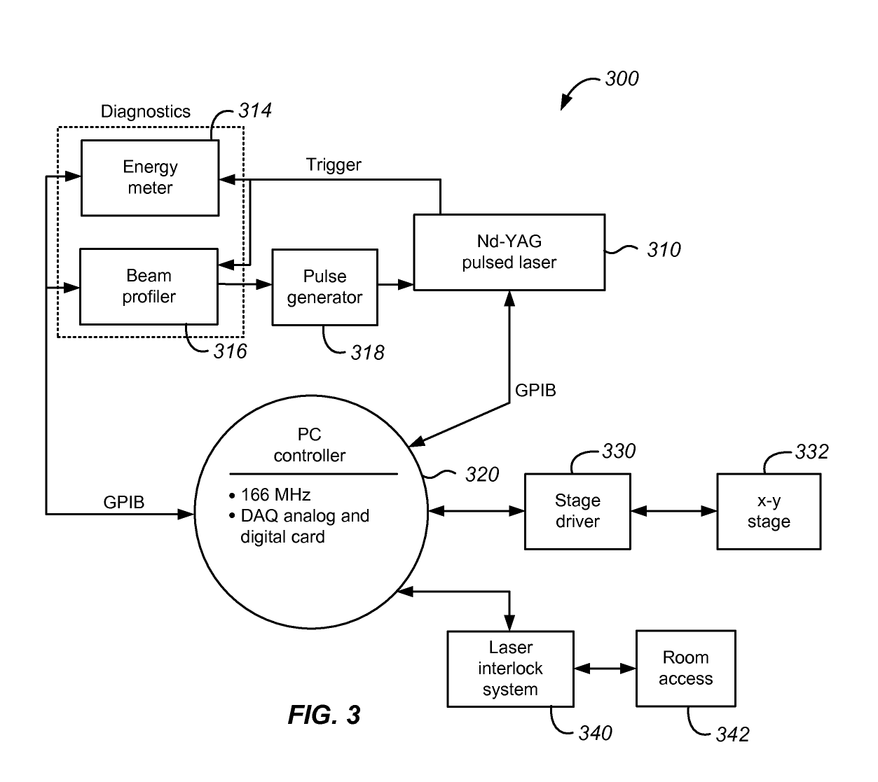

FIG. 3 is a simplified schematic diagram of a control system layout for the system illustrated in FIG. 2. The system 300 includes a high power laser 310 (also depicted as 232 in FIG. 2). Laser diagnostics associated with the high power laser 310 include an energy meter 314 and a beam profiler 316. In the illustrated embodiment, a separate pulse generator 318 is provided although this element can be integrated into the high power laser 310 in other embodiments. The high power laser 312 and an optional low power laser (not shown) are in electrical communication with a controller 320, which may be a PC-based controller with analog and digital inputs/outputs. The controller 320 can also be referred to as a processor or a data processor. A detector can be provided in communication with the controller 320 and be used in detecting the locations, sizes, and other characteristics associated with the inclusions discussed throughout the present specification. A stage driver 330 is in communication with x-y stage 332 and controller 320 to provide for motion of the optical element as described herein. In other embodiments, additional degrees of freedom are utilized in positioning of the optical element and/or the incident laser beam. In some embodiments, a laser interlock system 340 and room access system 342 are utilized to provide physical protection for systems and personnel. One of ordinary skill in the art would recognize many variations, modifications, and alternatives.

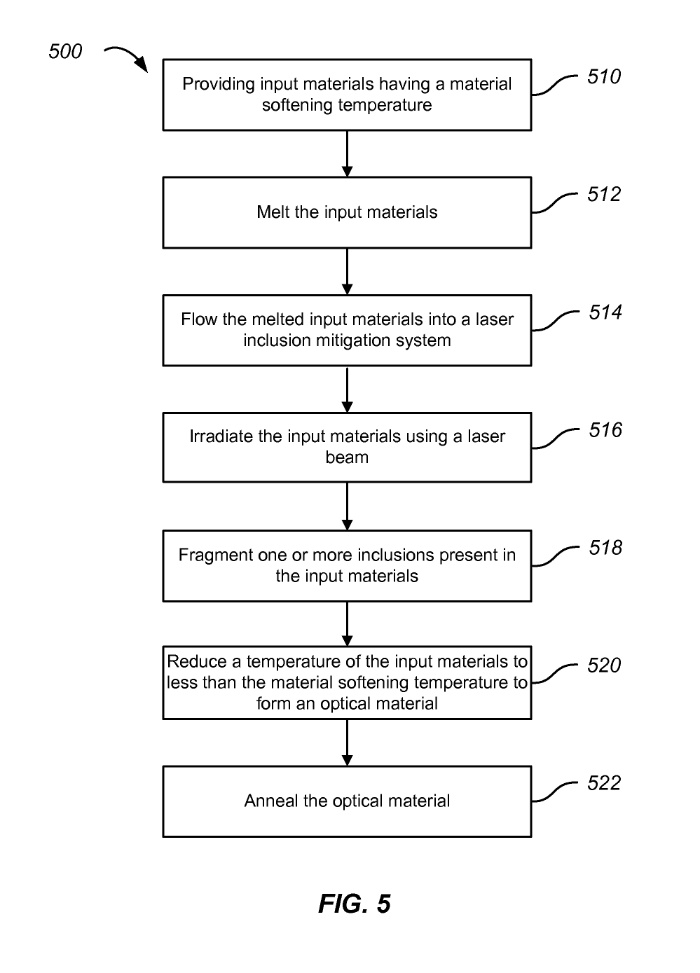

FIG. 5 is a simplified flowchart illustrating a method of mitigating inclusions according to an embodiment of the present invention. The method 500, which is applicable to the fabrication of optical materials, includes providing input materials having a high temperature softening range (510). The input materials can be the precursors for the fabrication of a variety of optical elements including laser gain media, passive optical components such as lenses and windows, Faraday rotator glass, Tb-doped phosphate glass, silicate glass, crystalline laser gain media, for example, rare-earth- or transition metal-doped crystals, or nonlinear laser optical materials. The optical elements can also include ceramic optical laser materials, e.g., Nd- or Tb-doped oxide garnets or fluorites (e.g., CaF₂, SrF₂, or the like).

The method also includes melting the input materials (512) and flowing the melted input materials into the laser inclusion mitigation system. The melted input materials include one or more particulate inclusions, typically resulting from the vessels in which melting, mixing, and other processing steps associated with the fabrication process are performed. In particular embodiments of the present invention, the inclusions are metallic platinum inclusions in glass although other metals, metal-based alloys, and ceramics are included within the scope of the present invention. The term particulate is not intended to limit the inclusions to a single metal element, but includes combinations of different metal elements, metal alloys including one or more metal elements, ceramic particles, and the like.

The method further includes irradiating the input materials using a laser beam (516) and fragmenting the one or more inclusions in response to the irradiating (518). As an example, a Nd-YAG or a Nd-Glass laser can be used to irradiate the input materials and fragment the inclusions. The laser wavelength is selected to provide for high transmission of the laser light through the input materials in order to reach the inclusions. Typically, the laser beam is scanned across the input materials, for example, in a raster scan format. The method includes reducing a temperature of the input materials to less than the material softening temperature (520) to form an optical material and annealing the optical material (522). In one embodiment illustrated in FIG. 5, laser processing to mitigate the inclusions is performed prior to cooling of the input materials to solidify the optical material (i.e., prior to cooling to a temperature less than the material softening temperature). In other embodiments, the laser processing is performed after the input materials have cooled through the material softening temperature but while the materials are in a plastic state. Thus, embodiments of the present invention are not limited to laser irradiation while the input materials are above the material softening temperature. One of ordinary skill in the art would recognize many variations, modifications, and alternatives.

Some embodiments utilize an inspection system in which the method 500 additionally includes scanning a second laser beam across the input materials, detecting light scattered from the melted input materials, and determining, using a processor, a location of an inclusion using the detected light. In these systems utilizing an inspection system, irradiating the input materials using the laser beam can include directing the laser beam to irradiate the inclusion at the location.

It should be appreciated that the specific steps illustrated in FIG. 5 provide a particular method of mitigating inclusions according to an embodiment of the present invention. Other sequences of steps may also be performed according to alternative embodiments. For example, alternative embodiments of the present invention may perform the steps outlined above in a different order. Moreover, the individual steps illustrated in FIG. 5 may include multiple sub-steps that may be performed in various sequences as appropriate to the individual step. Furthermore, additional steps may be added or removed depending on the particular applications. One of ordinary skill in the art would recognize many variations, modifications, and alternatives.

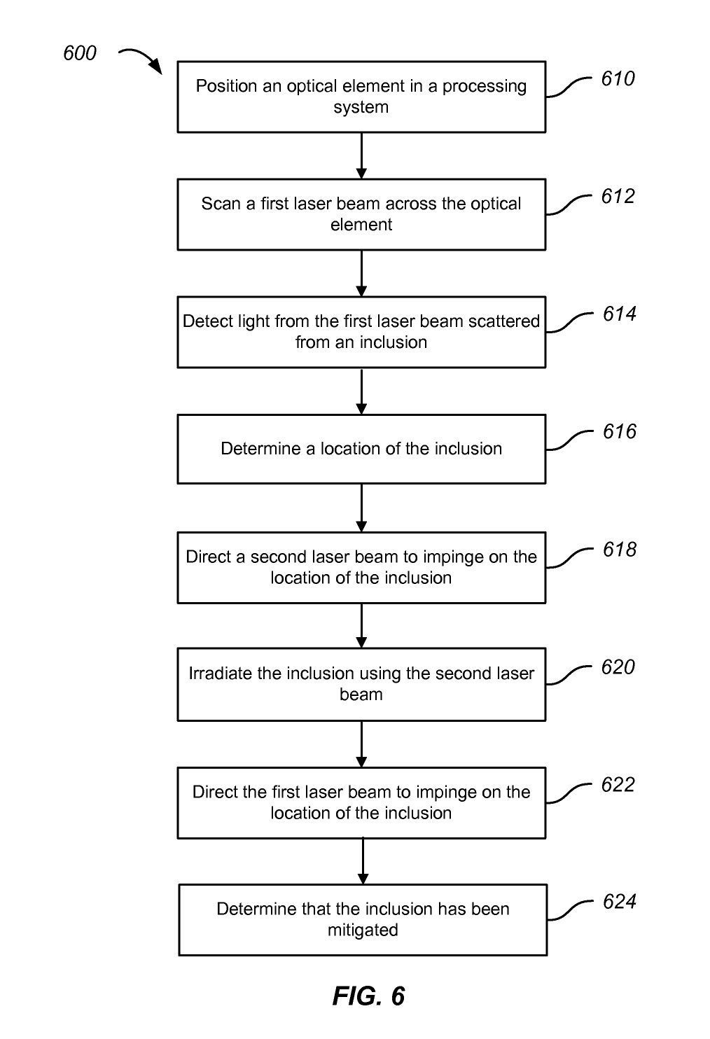

FIG. 6 is a simplified flowchart illustrating a method of processing an optical element according to an embodiment of the present invention. The method 600 includes positioning the optical element in a processing system (610). The optical element initially includes at least one inclusion. As an example, the inclusion can be a metallic platinum inclusion that exists as a result of the fabrication processes used to fabricate the optical element. Thus, passive optical elements such as lenses, active optical elements such as gain materials, and other optical elements are included within the scope of the present invention. The method also includes scanning a first laser beam across the optical element (612), detecting light from the first laser beam scattered from at least one inclusion (614) and determining a location of the inclusion (616). In some embodiments, the first laser beam is part of a low power laser scanning system that utilizes one or more lasers, optics, one or more detectors, and a processor to determine the locations of inclusions. Scattering from the inclusions as discussed in relation to FIG. 2 can be utilized in some embodiment.

The method further includes directing a second laser beam to impinge on the inclusion (618) and irradiating the inclusion (620). The irradiation of the inclusion results in fracturing of the inclusion or other mitigation processes that reduce the size and/or optical effects of the inclusion, typically using a high power laser. In some embodiments, the temperature of the optical element is controlled to be at approximately a material softening temperature associated with the optical element so that irradiation results in absorption of part or all of the inclusion into the bulk of the optical element. The dwell time, number of laser pulses, or the like can be varied to provide sufficient fluence to mitigate the inclusion(s).

In some embodiments, the low power scanning laser system is utilized to verify the mitigation of the inclusion after irradiation. In these embodiments, the method includes directing the first laser beam to impinge on the inclusion (622) and determining that the inclusion has been mitigated (624). Thus, a monitoring system can sense a reduction in scattering, absorption, or the like associated with an inclusion and provide inputs to a feedback loop to provide additional irradiation until the inclusion is mitigated to a predetermined level. The optical element can be annealed as part of the method of after the inclusion is irradiated. One of ordinary skill in the art would recognize many variations, modifications, and alternatives.

It should be appreciated that the specific steps illustrated in FIG. 6 provide a particular method of processing an optical element according to an embodiment of the present invention. Other sequences of steps may also be performed according to alternative embodiments. For example, alternative embodiments of the present invention may perform the steps outlined above in a different order. Moreover, the individual steps illustrated in FIG. 6 may include multiple sub-steps that may be performed in various sequences as appropriate to the individual step. Furthermore, additional steps may be added or removed depending on the particular applications. One of ordinary skill in the art would recognize many variations, modifications, and alternatives.

In addition to applications for optically active materials, embodiments of the present invention are applicable to passive optical elements, including lenses and windows made of other silicate optical glasses, such as BK-7. For current high average power laser systems, silicate glass optics, due to the presence of inclusions, are only used in locations associated with low irradiance. High irradiance portions of the system utilize more expensive forms of fused silica that are free of inclusions. Embodiments of the present invention enable the use of less expensive silicate glasses at both low irradiance and high irradiance portions of high average power laser systems. Although embodiments of the present invention are discussed in relation to high average power laser systems, embodiments of the present invention are also applicable to other laser systems including high power laser systems. One of ordinary skill in the art would recognize many variations, modifications, and alternatives.

In addition to applications related to silicate and phosphate glass, embodiments of the present invention are not limited to this particular material system, but are applicable to other optical materials, including optical ceramics. Optical ceramics is a term including a variety of materials such as ceramic neodymium-doped yttrium aluminum garnet (Nd:YAG), ytterbium-doped YAG (Yb:YAG), neodymium-doped fluorite ceramics (e.g., Nd:CaF₂, Nd:SrF₂, or the like), ytterbium-doped fluorite ceramics (e.g., Yb:CaF₂, Yb:SrF₂, etc.) or ceramic materials doped with other optically active elements. Additionally, ceramic Faraday Rotator materials (e.g., terbium gallium garnet (TGG) or terbium aluminum garnet (TAG)) can be fabricated and/or processed using embodiments of the present invention. As described throughout the present specification, embodiments of the present invention are applicable in improving the durability of a variety of existing and new optical materials.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A method of fabricating an optical material, the method comprising:
providing input materials having a glass softening temperature;
melting the input materials;
flowing the melted input materials onto a conveyor, wherein the melted input materials comprise one or more inclusions;
irradiating the input materials using a laser beam;
fragmenting the one or more inclusions in response to the irradiating;
reducing a temperature of the input materials to less than the glass softening temperature;
forming an optical material; and
annealing the optical material.

2. The method of claim 1 wherein the input materials comprise silicate glass.

3. The method of claim 2 wherein the inclusion comprises metallic platinum.

4. The method of claim 1 wherein the input materials are at a temperature greater than the glass softening temperature during the irradiating step.

5. The method of claim 1 wherein irradiating the input materials comprises scanning the laser beam across the input materials.

6. The method of claim 1 further comprising:
scanning a second laser beam across the input materials;
detecting light scattered from the input materials; and
determining, using a processor, a location of an inclusion using the detected light.

7. The method of claim 6 wherein irradiating the input materials using the laser beam comprises directing the laser beam to irradiate the inclusion at the location.

8. The method of claim 1 wherein the laser beam comprises radiation at a wavelength associated with transparency of the softened material.

9. A method of processing an optical element, the method comprising:
positioning the optical element in a processing system, wherein the optical element initially includes at least one inclusion;
scanning a first laser beam across the optical element;
detecting light from the first laser beam scattered from the at least one inclusion;
determining a location of the at least one inclusion;
directing a second laser beam to impinge on the at least one inclusion;
irradiating the at least one inclusion;
directing the first laser beam to impinge on the at least one inclusion; and
determining that the at least one inclusion has been mitigated.

10. The method of claim 9 wherein the optical element comprises an active optical element.

11. The method of claim 9 wherein the optical element comprises a passive optical element.

12. The method of claim 9 wherein the inclusion comprises a metallic platinum inclusion.

13. The method of claim 9 further comprising controlling a temperature of the optical element to be at approximately a glass softening temperature associated with the optical element.

14. The method of claim 9 wherein irradiating the inclusion comprises dispersing the metallic inclusion.

15. The method of claim 9 further comprising annealing the optical element after irradiating the inclusion.

16. A system for fabricating optical materials, the system comprising:
a melt system operable to receive and melt input materials;
a material feed system coupled to the melt system and operable to feed the melted input materials;
a conveyer system operable to receive the melted input materials and translate the melted input materials along a conveyer;
an oven surrounding at least a portion of the conveyor; and
a laser system operable to irradiate the melted input materials using a laser beam.

17. The system of claim 16 wherein the input materials comprise silicate glass.

18. The system of claim 16 wherein the melted input materials are in at least a softened or plastic state during irradiation.

19. The system of claim 16 wherein the laser system comprises a scanning device operable to scan the laser beam across the melted input materials.

20. The system of claim 16 further comprising a detection system including:
a laser scanner operable to scan a beam across the melted input materials; and
a detector operable to receive light scattered from the melted input materials;
a processor coupled to the detector; and
a controller coupled to the laser system and operable to direct the laser beam.

21. The system of claim 16 wherein the laser system comprises at least one of an Nd:YAG laser or a laser characterized by a wavelength associated with transparency of the optical materials.
